(19) United States
(12) Patent Application Publication
(10) Pub. No.: US 2011/0243537 A1
(43) Pub. Date: Oct. 6, 2011

(54) Motion control of impedance-type haptic devices

(76) Inventors: Robert P. Wilson, Mountain View, CA (US); Günter Niemeyer, Mountain View, CA (US)

(21) Appl. No.: 12/932,021

(22) Filed: Feb. 16, 2011

Related U.S. Application Data
(60) Provisional application No. 61/338,271, filed on Feb. 16, 2010.

(51) Int. Cl. H02P 7/24

(52) U.S. Cl. 388/847

(57) ABSTRACT

A control method for an haptic device is provided with particular attention to motor control amplifiers exploiting the inate motor dynamics of DC motors. The control method encompasses a digital and analog circuit. In the digital circuit, a command voltage is determined by a digital controller utilizing sensed motion information of the haptic device and a motion command signal. In the analog circuit, an amplifier applies a voltage to an electrical DC motor. The applied voltage incorporates the determined command voltage from the digital controller and a voltage to reduce the electrical dynamics of the electrical DC motor.

### CROSS-REFERENCE TO RELATED APPLICATIONS

This application claims priority from U.S. Provisional Patent Application 61/338,271 filed Feb. 16, 2010, which is incorporated herein by reference.

### FIELD OF THE INVENTION

The invention relates to haptics, robotics and motor control. In particular, the invention relates to motor control amplifiers exploiting the inate motor dynamics of DC motors.

### BACKGROUND OF THE INVENTION

Haptic interfaces allow users to feel virtual or remote environments by interacting with a robotic master device coupled to a computer simulation or robotic slave. The effective rendition of interactions ranging from free motion to rigid contact with a virtual surface is a central goal in haptic simulation. Two types of interfaces are commonly discussed, admittance and impedance, describing the causality of the user interaction. The invention is concerned with impedance-type haptic devices which try to accomplish this by producing forces in response to contacts in the virtual environment as a result of motion caused by the user. In the case of free motion, these devices work very well, since they are generally designed to be easily back-driven by the user. Stable simulation of high-stiffness contact, on the other hand, remains a challenge. The present invention addresses this challenge.

### SUMMARY OF THE INVENTION

The present invention pertains to methods of controlling an haptic device with particular attention to motor control amplifiers exploiting the inate motor dynamics of DC motors (linear or rotary motors). The control method encompasses a digital and analog circuit. In the digital circuit, a command voltage is determined by a digital controller utilizing sensed motion information of the haptic device and a motion command signal. In the analog circuit, an amplifier applies a voltage to an electrical DC motor. The applied voltage incorporates the determined command voltage from the digital controller and a to voltage to reduce the electrical dynamics of the electrical DC motor (i.e. resistance and/or inductance). The electrical dynamics of the DC motor can be reduced by a voltage according to (i) a positive current feedback voltage, (ii) a positive feedback compensator, or (iii) a negative impedance convertor. Exemplary descriptions are included pertaining to rotary motor, but are not limited to these type of motors as they can also be applied to linear motors.

### BRIEF DESCRIPTION OF THE DRAWINGS

FIG. 1 shows according to an exemplary embodiment of the invention the mapping of motor inductance and residual resistance from the electrical domain to the mechanical domain.

FIG. 2 shows according to an exemplary embodiment of the invention 3-phase BLDC motor windings in WYE configuration.

FIG. 3 shows according to an exemplary embodiment of the invention frequency-dependant rendered stiffness of the combined spring drive and controller. The unmodified motor dynamics (dotted curve) are included for comparison.

FIG. 4 shows according to an exemplary embodiment of the invention a purely motion based virtual environment-device interaction.

FIG. 5 shows according to an exemplary embodiment of the invention a system block diagram: A drift-compensating mid-level controller interfacing the quasi-static environment to the device, which is operated as a motion source.

FIG. 6 shows according to an exemplary embodiment of the invention cartesian stiffness ellipses Kₓ^{inv} and Kₓ^{trans} with α=λₘᵢₙ[(JJ^{T})−1] for a 2-DOF manipulator (PHANTOM with locked base joint).

### DETAILED DESCRIPTION

### 1. Spring Drive

The use of a voltage motor drive with resistive or resistive and inductive load compensation, which we will refer to as a spring drive for brevity, improves the haptic rendering of rigid contact when compared to standard current drive motor amplifiers. The key idea underlying this improvement is slowing the electrical dynamics and allowing the inductance to be utilized as a high-stiffness haptic coupling. This concept and the corresponding notation are covered briefly in this section.

The electrical dynamics of a typical brushed dc motor are

$${e}_{A} ( t ) = Ri ( t ) + L \frac{d i ( t )}{d t} + {e}_{B} ( t ) \qquad ( 1 )$$

with coupling equations:

e_{B}(t)=k_{T}\dot{θ}(t) (2)

τ(t)=k_{T}i(t), (3)

where e_{A} is the applied voltage, e_{B} is the back-EMF, k_{T} is the torque/speed constant, τ is the motor torque, i is the winding current, \dot{θ} is the rotor velocity, and R and L are the winding resistance and inductance, respectively. To pursue a haptic perspective on the effects of driving a motor with the spring drive, it is useful to interpret R and L as an equivalent mechanical spring K_{L}

$${K}_{L} = \frac{{k}_{T}^{2}}{L} \qquad ( 4 )$$

and damper B_{R},

$${B}_{R} = \frac{{k}_{T}^{2}}{R} , \qquad ( 5 )$$

where K_{L} and B_{R} are connected in series. The spring drive approach couples the haptic device to the virtual environment through K_{L}, which is available at all frequencies, inherently stable, and very stiff for small L. It does this by eliminating the series B_{R} through cancellation the winding resistance.

Resistance cancellation is accomplished by setting

e_{A}=\hat{R}i+e_{W} (6)

where \hat{R} is a conservative estimate of R. This effectively cancels the voltage drop across the winding resistance, while allowing additional voltage inputs e_{W}. Since the motor resistance R varies with temperature and brush commutation, a residual uncancelled resistance

dR(T,θ)=R(T,θ)−\hat{R}, (7)

will remain. It corresponds to the residual series damper

$${B}_{dR} = \frac{{k}_{T}^{2}}{d R} . \qquad ( 8 )$$

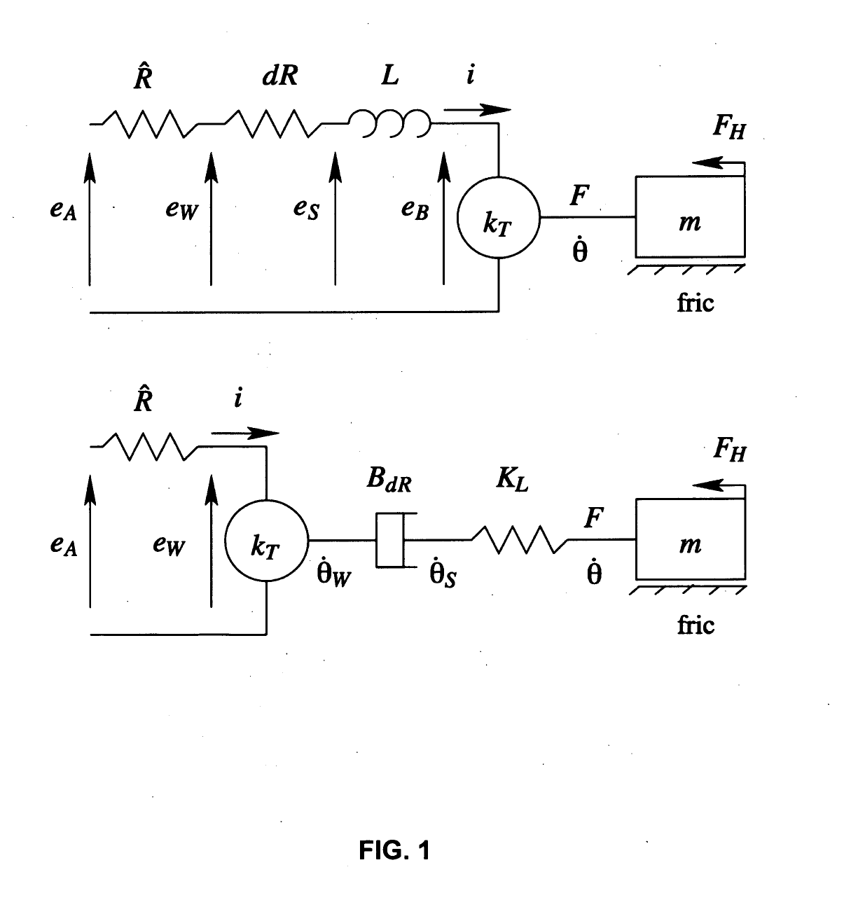

FIG. 1 shows the mapping of winding inductance L and residual resistance dR into the mechanical domain, leaving \hat{R} to be canceled by Equation 6. By the electromechanical coupling (Equation 2), the intermediate voltages e_{W} and e_{S} relate to the velocities \dot{θ}_{W} and \dot{θ}_{S}, respectively; where e_{W} is the applied node voltage between the series resistances \hat{R} and dR, e_{S} is the node voltage between R and L, \dot{θ}_{W} is the velocity of the setpoint of the mechanical equivalent series spring-damper, and \dot{θ}_{S} is the velocity of the connection point between the series spring and damper. With the inductance and residual resistance interpreted in the physical domain, voltage commands to the spring drive are equivalent to velocity commands to the set-point of the series spring-residual damper

e_{W}=k_{T}θ_{W}. (9)

Therefore, the spring drive operates the dc motor as an approximate motion source. This is in contrast with the current drive motor amplifiers typically used in haptic devices, which speed up the electrical dynamics and operate the motor as a torque source. By recasting the motor as a motion source, it becomes necessary to design the digital controller as a motion controller, again in contrast to the impedance control typically paired with the current drive.

It is important to note that L may be canceled in addition to R, effectively increasing the stiffness K_{L}. In this case (Equation 6) becomes

$${e}_{A} = \hat{R} i + \hat{L} \frac{d i ( t )}{d t} + {e}_{W} \qquad ( 10 )$$

where \hat{L} is an estimate of L.

### 1.1. Spring Drive Implementation

Implementation of Equation 6 may be realized via various analog circuit architectures. One option is to use a sense resistor to measure current through the motor, apply a gain of \hat{R} to the resulting voltage signal, and use a positive feedback loop to route this signal to the input of a suitable voltage amplifier that drives the motor. The command signal e_{W} is summed with the current feedback signal to produce e_{A}, which is the input to the voltage amplifier. To add cancellation of L, the derivative term

$$\hat{L} \frac{d i ( t )}{d t}$$

is added to the positive current feedback path.

Another option is to employ a negative impedance converter (NIC). A NIC is an analog op-amp circuit that acts like a negative load. Here, a power op-amp NIC with an effective impedance of −\hat{R} or −(\hat{R}+\hat{L}_{S}) is used to drive the motor.

### 2. Brushless DC Motor

The compensation of brushed DC motor dynamics described above utilizes a single-value model of R. Brushed DC motors, however, experience resistance discontinuities due to commutation, and this can cause discontinuities in the haptic force experienced by the user during. Here, we extend the idea of utilizing the natural motor dynamics through resistance compensation to brushless DC (BLDC) motors, in part to address this issue. More generally, however, BLDC motors out-perform brushed DC motors, exhibiting higher power density, reliability, and efficiency. They also have lower rotor inertia and torque ripple (with sinusoidal commutation). This section will review the operation and dynamics of BLDC motors before a description of BLDC resistance compensation in the next section.

Brushless DC motors are constructed with the permanent magnet located on the rotor and several (usually three) windings on the stator. By moving the permanent magnet to the rotor, there is no need to supply current to the rotating element, and brushes or slip rings are unnecessary. In the case of the three phase BLDC motor, the windings are each separated by an angle of 120 degrees. Each winding experiences a sinusoidal back-EMF voltage. External circuitry and control is necessary to commutate a BLDC motor, and several methods are available, most notably six-step block commutation and sinusoidal commutation. The former is inexpensive, requiring only three Hall sensors, which are usually integrated into the motor. Sinusoidal commutation requires position feedback via an encoder or resolver, but theoretically has no torque ripple and can be used for positioning applications.

The electrical dynamics of a three-phase BLDC are,

$$\begin{matrix}{e}_{{A}_{1}} ( t ) - {e}_{n} ( t ) = {R}_{1} {i}_{1} ( t ) + {L}_{1} \frac{d {i}_{1} ( t )}{d t} + {e}_{{B}_{1}} & ( 11 ) \\ {e}_{{A}_{2}} ( t ) - {e}_{n} ( t ) = {R}_{2} {i}_{2} ( t ) + {L}_{2} \frac{d {i}_{2} ( t )}{d t} + {e}_{{B}_{2}} & ( 12 ) \\ {e}_{{A}_{3}} ( t ) - {e}_{n} ( t ) = {R}_{3} {i}_{3} ( t ) + {L}_{3} \frac{d {i}_{3} ( t )}{d t} + {e}_{{B}_{3}} & ( 13 )\end{matrix}$$

with the back-EMF voltages,

e_{B}_{₁}=k_{T}\dot{θ} sin(θ) (14)

e_{B}_{₂}=k_{T}\dot{θ} sin(θ−120°) (15)

e_{B}_{₃}=k_{T}\dot{θ} sin(θ+120°) (16)

Note that by definition the three currents add to zero

i₁+i₂+i₃=0 (17)

and each winding contributes a torque in a sinusoidal fashion

τ₁=k_{T}i₁ sin(θ) (18)

τ₂=k_{T}i₂ sin(θ−120°) (19)

τ₃=k_{T}i₂ sin(θ+120°) (20)

with the total torque

τ=τ₁+τ₂+τ₃. (21)

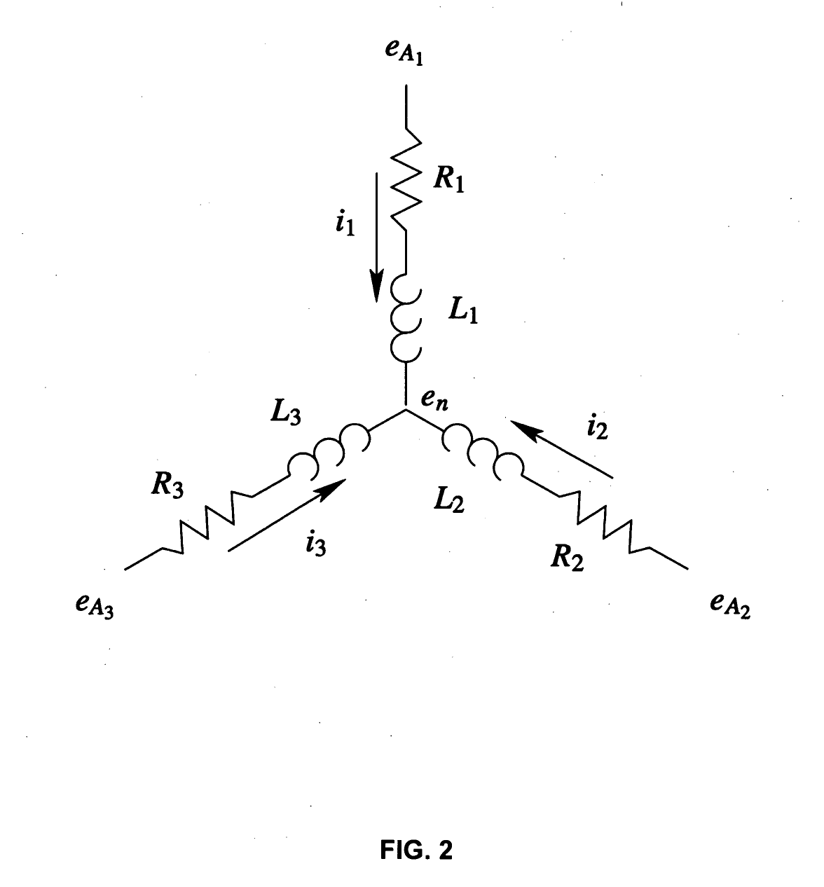

FIG. 2 shows the corresponding BLDC windings in a wye configuration.

Sinusoidal commutation is used to provide constant torque versus the rotor angle and allow for position control. This means that for a given voltage command, e_{W}, the commutated voltage commands to each winding are,

e_{W}_{₁}=e_{W} sin(θ) (22)

e_{W}_{₂}=e_{W} sin(θ−120°) (23)

e_{W}_{₃}=e_{W} sin(θ+120°) (24)

### 3. Exploiting BLDC Motor Dynamics

Utilizing the natural dynamics of a BLDC motor to couple a user to the virtual environment is conceptually identical to the approach taken for brushed DC motors. However, now the resistances of three separate windings must be canceled by a trio of compensators. For the following analysis an ideal case is considered where the resistances and inductances of each of the three windings are identical and equal to R and L, respectively. As a consequence, by adding Equations 11-13 the common node voltage is the mean of the three terminal voltages,

$${e}_{n} = \frac{{e}_{{A}_{1}} + {e}_{{A}_{2}} + {e}_{{A}_{3}}}{3} \qquad ( 25 )$$

All three drivers cancel the resistance, while allowing sinusoidally commutated voltage input eW

e_{A}_{₁}(t)=\hat{R}i₁(t)+e_{W} sin(θ) (26)

e_{A}_{₂}(t)=\hat{R}i₂(t)+e_{W} sin(θ−120°) (27)

e_{A}_{₃}(t)=\hat{R}i₃(t)+e_{W} sin(θ+120°) (28)

such that from Equation 25 and Equation 17 the common node voltage en=0. Substituting Equations 26-28 into Equations 11-13 yields,

$$\begin{matrix}\frac{d {i}_{1}}{d t} = - \frac{{k}_{T}}{L} \dot{θ} sin ( θ ) & ( 29 ) \\ \frac{d {i}_{2}}{d t} = - \frac{{k}_{T}}{L} \dot{θ} sin ( θ - 120 ° ) & ( 30 ) \\ \frac{d {i}_{3}}{d t} = - \frac{{k}_{T}}{L} \dot{θ} sin ( θ + 120 ° ) & ( 31 )\end{matrix}$$

Integrating and substituting each i into Equations 18-20, 21 provides the result,

$$τ ( t ) = - \frac{{k}_{T}^{2}}{L} [ cos ( {θ}_{0} ) sin ( θ ) + cos ( {θ}_{0} - 120 ° ) sin ( θ - 120 ° ) + cos ( {θ}_{0} + 120 ° ) sin ( θ + 120 ° ) ] \qquad ( 32 )$$

where θ₀=θ(0) with τ(0)=0. This simplifies to

$$τ ( t ) = - \frac{3 {k}_{T}^{2}}{2 L} sin ( θ - {θ}_{0} ) . \qquad ( 33 )$$

Thus, over small angles the equivalent inductive spring for a BLDC motor is

$${K}_{L} = \frac{3 {k}_{T}^{2}}{2 L} \qquad ( 34 )$$

In the case where the current feedback gain of the controller is not exactly R, a small resistance dR remains uncancelled leading to an equivalent resistive damper:

$${B}_{R} = \frac{3 {k}_{T}^{2}}{2 dR} \qquad ( 35 )$$

It is important to note that B_{R} causes drift at low frequencies, while K_{L} dominates at high frequencies. The cutoff frequency between the two effects is

$${ω}_{cutoff} = \frac{dR}{L} .$$

As in Equation 10 the BLDC drivers may also compensate for L to produce a higher inductive stiffness.

### 4. Mid-Level Drift Compensation

Before any high-level controller can be successfully implemented, the fact that a residual damper B_{dR} exists between the commanded location θ_{W} and the output must be addressed. Without compensation, B_{dR} will allow θ_{S} and θ to drift unboundedly under low frequency external loads. In haptic applications this drift will degrade the simulation by making sustained rigid contacts feel like dampers. Therefore, position feedback with PD compensation is added digitally to combat drift and yields the control law

e_{W}=k_{T}\dot{θ}_{S}_{_{d}}+K_{D}(\dot{θ}_{S}_{_{d}}−\dot{θ})+K_{P}(θ_{S}_{_{d}}−θ), (36)

where K_{P} and K_{D} are the error gains and θ_{S}_{_{d}} and \dot{θ}_{S}_{_{d}} are the desired motion of the setpoint of the haptic coupling. We assume a first order filter with cutoff frequency λ on the differentiated velocity signal \dot{θ}. This constitutes a mid-level controller interface between the analog inductive stiffness of the spring drive and the high-level motion controller described in the next section. It is applicable to both brushed DC and BLDC motors. Implementation of this mid-level controller establishes a hybrid coupling between the user and the virtual environment consisting of the physical motor dynamics, analog electronics modifying these dynamics, and digital drift compensation. The combined physical and analog components comprise the series spring-damper shown in FIG. 1, while the digital component connects the parallel spring-damper of Equation 36 between θ and θ_{S}_{_{d}}. Functionally, the analog stiffness K_{L} dominates for high frequency deflections, while the digital mid-level controller pro-vides low to mid frequency stiffness. The frequency-dependent stiffness transfer function for the complete coupling is found by substituting Equation 36 into the resistance-canceled motor dynamics. For the modified brushed DC motor dynamics

$${e}_{W} ( t ) = dRi ( t ) + L \frac{d i ( t )}{d t} + {e}_{B} ( t ) \qquad ( 37 )$$

the stiffness transfer function is

$$\begin{matrix}{K}_{θ} ( s ) = \frac{τ}{θ} ( s ) \\ = - \frac{{k}_{T}}{Ls + dR} \frac{λ}{s + λ} [ ( ( {k}_{T} + {K}_{D} + \frac{{K}_{P}}{λ} ) s + {K}_{P} ) + \frac{{k}_{T} {s}^{2}}{λ} ] .\end{matrix} \qquad ( 38 )$$

The corresponding BLDC motor stiffness transfer function may be found similarly.

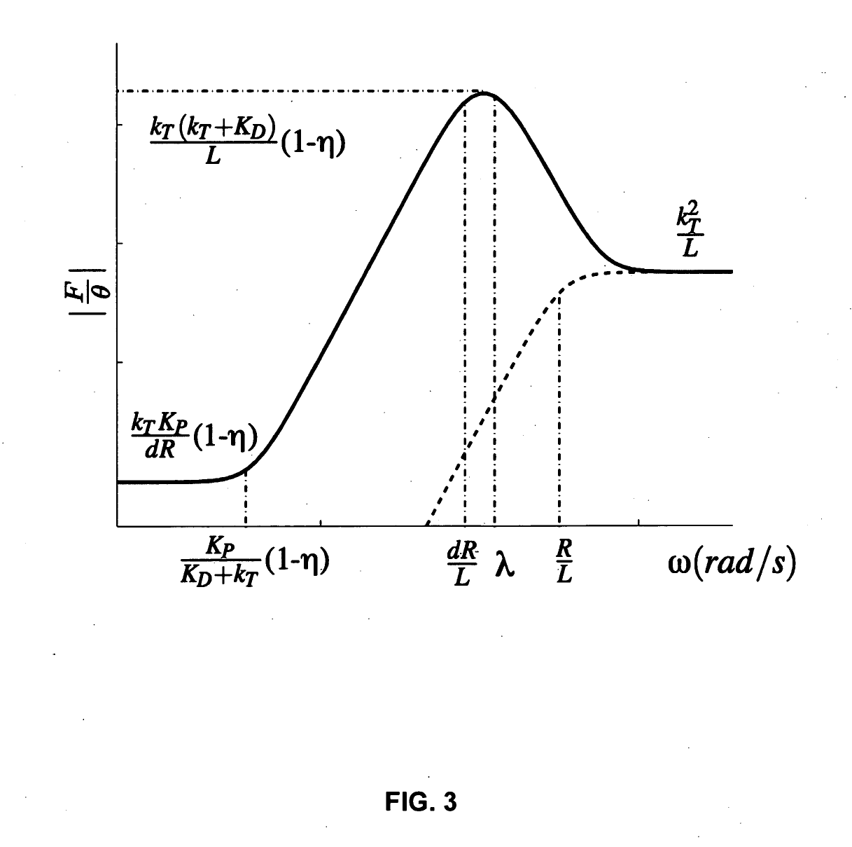

The magnitude Bode plot of Equation 38 shown in FIG. 3 illustrates the combination of several factors that shape stiffness over frequency. Starting from the natural motor dynamics represented by the dotted curve, the spring drive lowers the corner frequency from R/L to dR/L. The proportional term in the mid-level controller then pulls the low frequency rolloff caused by B_{dR} up to a dc stiffness

$${K}_{DC} = \frac{{k}_{T} {K}_{P}}{dR} , \qquad ( 39 )$$

while the derivative term boosts stiffness at midrange frequencies before the filter rolls it off to the high frequency stiffness

$${K}_{HF} = {K}_{L} = \frac{{k}_{T}^{2}}{L} . \qquad ( 40 )$$

As described earlier, K_{L} may be increased by electrically reducing L in addition to R, replacing L in the equations above with a residual inductance dL.

Thus, for a given motor the spring drive approach calls for the robustly stable minimization of dR and maximization of K_{P} and K_{D} to achieve the highest possible maximum stiffness at all frequencies. This tuning is then locked in place and the resulting K_{θ}(s) is treated as a passive coupling between the rotor angle θ and the setpoint θ_{S}_{_{d}}. This K_{θ}(s), which we will refer to as the coupling stiffness, represents the stiffest contact that the virtual environment can render on this actuator.

### 5. Motion Control of Haptic Devices: One-DOF

By treating the spring driven DC motor and the mid-level drift compensator as a black-boxed motion source that accepts setpoint motion commands θ_{S}_{_{d}} and θ_{S}_{_{d}}, we now describe a high-level motion controller in the form of a quasi-static virtual environment (VE). This approach combines the excellent free-space performance of an impedance-type device with the improved contact performance of an admittance-like controller. The structure of this VE is developed here for the one-DOF case before generalization to multiple degrees of freedom in the next section.

As noted, θ_{S}_{_{d}} and \dot{θ}_{S}_{_{d}} command the setpoint of the coupling stiffness K_{θ}(s). Thus, it is sufficient for the haptic simulation to implement a very simple, purely motion-based VE that uses a virtual proxy or tool to determine θ_{S}_{_{d}}, effectively using the coupling stiffness as the connection between the user and the VE. Rigid contact is easily rendered by commanding zero motion and locking the coupling stiffness

\dot{θ}_{S}_{_{d}}=0 θ_{S}_{_{d=θ}}₀, (41)

where θ₀ is the location of the contact constraint. Freespace is accomplished by setting the desired motion to track the user

\dot{θ}_{S}_{_{d}}=\dot{θ} θ_{S}_{_{d}}=θ. (42)

A slight lag in filtering the velocity may cause the system to create slight non-zero forces, equivalent to an added mass. Given the low bandwidth of human actions compared to the speed of filtering, however, any added mass tends to fall far below perceptible levels.

Finally, compliant contact is achieved by setting the desired motion to a fraction of the user motion. The full dynamic range of the VE can be represented by

θ_{S}_{_{d}}=η\dot{θ} θ_{S}_{_{d}}=ηθ+(1−η)θ₀ (43)

where 0≦η≦1, and η=0 and η=1 correspond to rigid contact and freespace, respectively. The low-frequency output stiffness is reduced by the factor η.

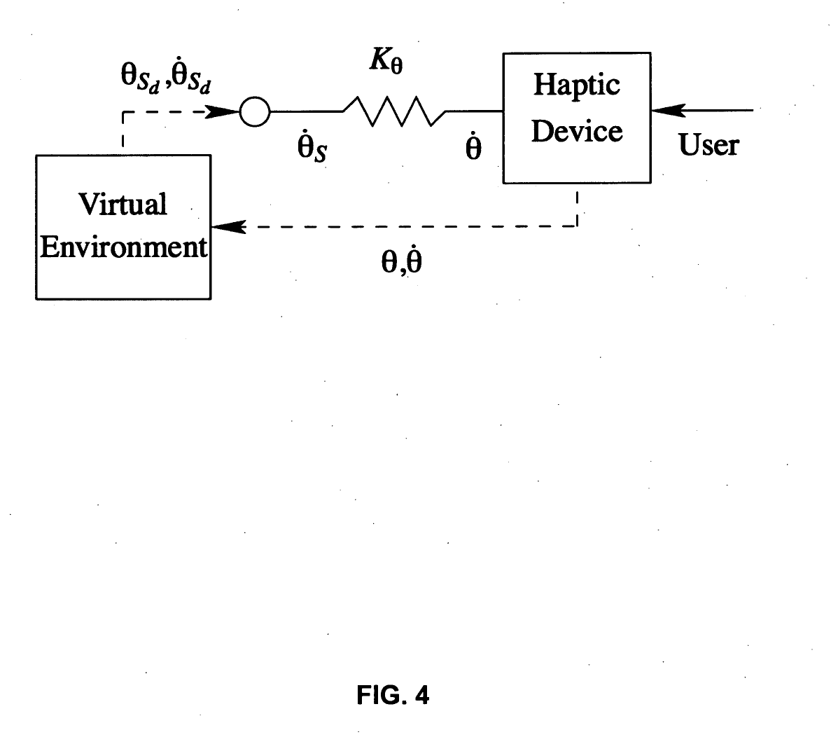

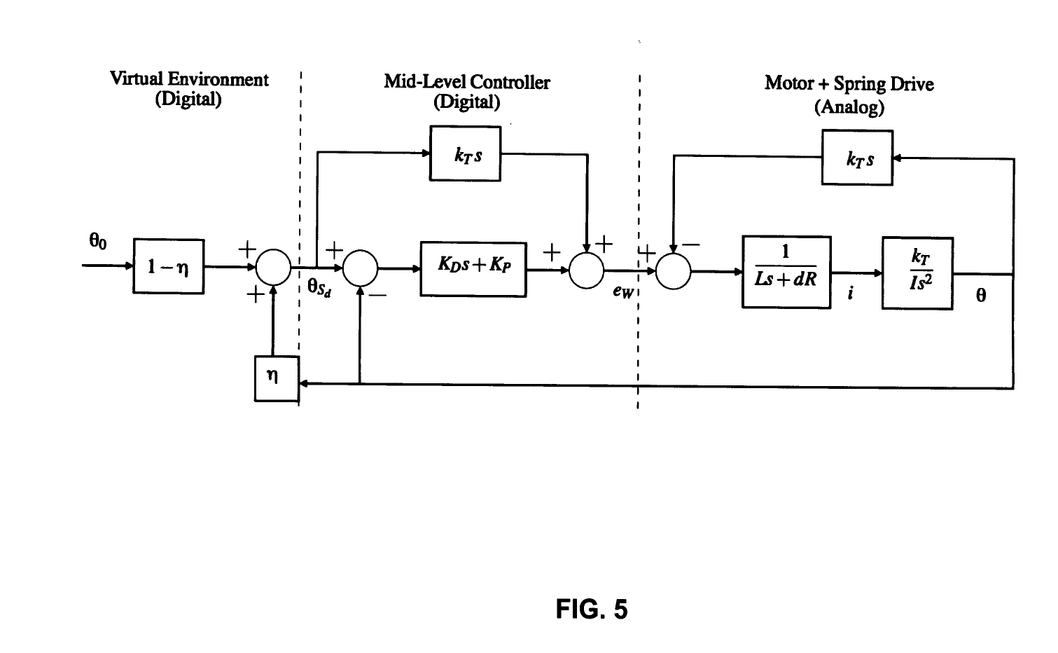

FIG. 4 shows the interaction between the virtual environment and the haptic device. The block diagram in FIG. 5 illustrates the implementation of the full system, including the spring drive, mid-level drift compensator, and virtual environment.

As a motion-based VE, no absolute force values are available, either explicitly via measurement or implicitly by commanding motor current. Output stiffnesses, therefore, may no longer be programmed exactly, but must be specified as a fraction of the device's maximum achievable stiffness. Knowledge of K_{θ}(s), particularly K_{DC}, can be used to estimate values.

### 6. Motion Control of Haptic Devices: Multi-DOF

In extending the above approach to multi-DOF haptics, we recognize the application's requirements. Though we wish to display the maximum achievable stiffness, force directions need to be rendered accurately to convey proper geometric surface properties. For example, forces should always fall perpendicular to frictionless surfaces. To support this requirement, perceived output stiffnesses need to be spatially uniform.

Given an n-DOF device, one drift-compensated spring drive is used to drive each joint motor. Thus, each joint independently replicates the one-DOF system previously described, acting as a joint motion source with a stiffness described by Equation 38. We assume here that all joints exhibit the same stiffness, though relative scaling between joints could be incorporated if necessary.

We define a desired Cartesian location \vec{x}_{S}_{_{d}} and velocity {right arrow over (\dot{x}_{S}_{_{d}}, and collect the individual joint values into a joint position vector \vec{q} and velocity vector q with equivalent desired position \vec{q}_{S}_{_{d}} and velocity {right arrow over (\dot{q}_{S}_{_{d}},

\vec{q}_{S}_{_{d}}=invkin(\vec{x}_{S}_{_{d}}) {right arrow over (\dot{q}_{S}_{_{d}}=J⁻¹{right arrow over (\dot{x}_{S}_{_{d}} (44)

obtained by inverting the mechanism's kinematics, where J is the Jacobian matrix of the mechanism's forward kinematics. This will produce joint torques

\vec{τ}=K_{q}Δ\vec{q} (45)

via a diagonal joint stiffness matrix

K_{q}=K_{θ}(s)I, (46)

which maps to a Cartesian stiffness of

Kₓ^{inv}=J^{-T}K_{q}J⁻¹=K_{θ}(s)(JJ^{T})⁻¹ (47)

remembering that

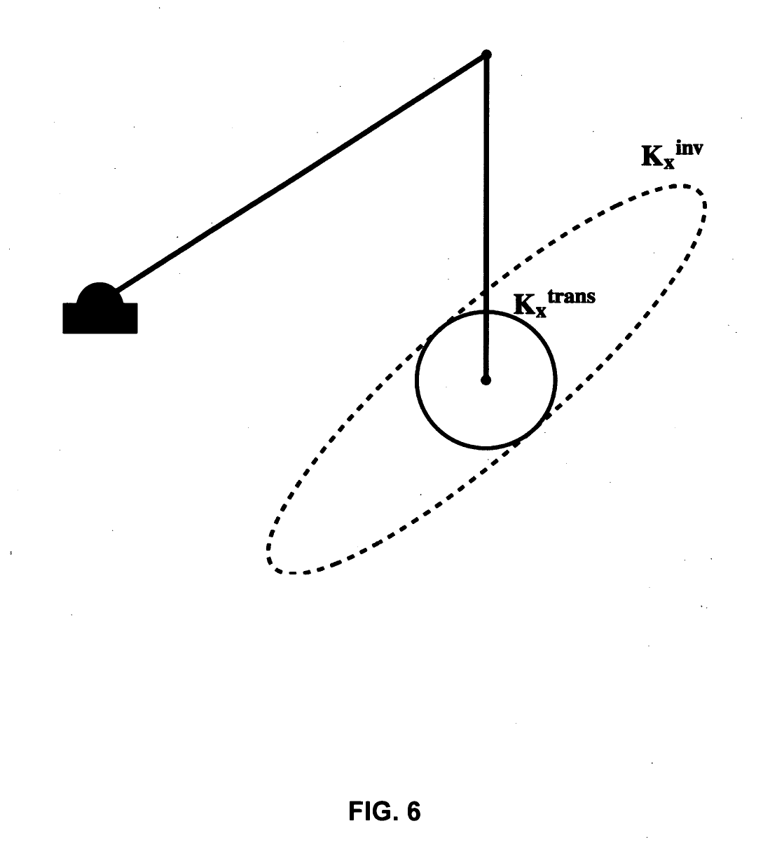

\vec{F}=Kₓ^{inv}Δ\vec{χ} \vec{τ}=J^{T}\vec{F} Δ\vec{χ}=JΔ\vec{q}. (48)

Where is the Cartesian force at the end effector, Δ\vec{χ}=(\vec{χ}_{Sd}−\vec{χ}), and Δ\vec{q}=(\vec{q}_{Sd}−\vec{q}). We denote the stiffness matrix with ‘inv’ to indicate the joint values were set by an inverse Jacobian kinematic algorithm. Unfortunately, this Cartesian stiffness is non-spherical such that forces are not necessarily generated along displacement vectors. FIG. 6 depicts such a stiffness ellipsoid for a simple 2-DOF case. Proper haptic rendering of force requires that the multi-DOF motion controller reshape this ellipsoid into a sphere. We instead calculate

\vec{q}_{Sd}=\vec{q}+αJ^{T}(\vec{x}_{Sd}−\vec{x}) (49)

where α is a scalar, and approximate the set-point derivative as

{right arrow over (\dot{q}_{Sd}={right arrow over (\dot{q}+αJ^{T}({right arrow over (\dot{x}_{Sd}−{right arrow over (\dot{x}), (50)

where we ignore the Jacobian's derivative. By construction this simplification only affects forces rendered at high velocities and high frequencies with minimal impact on user perception as discussed at the end of this section. This delivers a Cartesian force vector \vec{F} of

\vec{F}=J^{-T}K_{q}αJ^{T}Δ\vec{x} (51)

and the Cartesion stiffness

Kₓ^{trans}=αJ^{-T}K_{q}J^{T}. (52)

Since K_{q} is the scaled identity matrix, Kₓ^{trans} collapses to the diagonal

Kₓ^{trans}=αK_{θ}(s)I. (53)

Effectively, the transpose equation 49 has reshaped the ellipsoid into a sphere and restored the force directions to parallel any deflections.

Having resolved the force direction problem, there is now the issue of what value to select for α. To address this, first recall that each joint is tuned for a maximum joint stiffness K_{θ}(s). Also note that locking each joint results in the Cartesian stiffness Kₓ^{inv}. Thus, Kₓ^{inv} represents the maximum achievable Cartesian stiffness for a given configuration, limited by the stability of each joint. Using the Jacobian transpose solution to the inverse kinematics has reshaped Kₓ^{inv} into the Cartesian stiffness ball Kₓ^{trans}, which must now be appropriately scaled by α. Intuitively, Kₓ^{trans} cannot be scaled arbitrarily large, as this would allow the effective Cartesian stiffness to be increased without bound. Indeed, if the magnitude of Kₓ^{trans} exceeds that of Kₓ^{inv} in any direction, we would be asking for a stiffness beyond the stable maximum. Doing this would effectively increase the gains of one or more joint controllers and compromise their stability. Therefore, taking Kₓ^{inv} as the upper bound to maintain stability, the eigenvalues of Kₓ^{trans} must satisfy

λₘₐₓ(Kₓ^{trans})≦λₘᵢₙ(Kₓ^{inv}). (54)

Substituting (53) and (47), this condition simplifies to

α≦λₘᵢₙ[(JJ^{T})⁻¹], (55)

where λmᵢₙ[(JJ^{T})−1] may be computed on the fly to maximize Kₓ^{trans} independently for each configuration, or computed over the entire workspace offline to select the global minimum for a consistent Kₓ^{trans} at all configurations.

FIG. 6 illustrates in an example the ellipses Kₓ^{inv} and Kₓ^{trans} with α=λₘᵢₙ[(JJ^{T})−1] for a PHANTOM constrained to 2-DOF by locking its base motor (three-degree of freedom, impedance-type haptic device).

The stiffness shape compensation performed by this multi-DOF VE does not have infinite bandwidth. As a result Kₓ^{inv} will still exist at high frequencies, and impulsive force vectors may be directed incorrectly. Since these direction discrepancies exist only at high frequency, however, the user will likely be unable to detect them kinesthetically, due to a low perceptual bandwidth of 20 Hz to 30 Hz. Tactile detection of the discrepancy may fare better, the direction discrimination threshold is only about 25 degrees, determined for perception of low frequency forces. Experience with a multi-DOF implementation on a PHANTOM 1.0 suggests that these discrepancies are not perceptible, and certainly not disruptive to the haptic simulation. Similar to the one-DOF case, compliant surfaces and free space may be obtained by setting

{right arrow over (\dot{x}_{Sd}=η{right arrow over (\dot{x} \vec{x}_{Sd}=η\vec{x}+(1−η)\vec{x}₀, (56)

with 0≦η≦1.

What is claimed is:

1. A method of controlling an haptic device, comprising:
a) in a digital circuit determining a command voltage by a digital controller, wherein said command voltage is determined from sensed motion information of said haptic device and a motion command signal; and
b) in an analog circuit applying by an amplifier a voltage to an electrical DC motor, wherein said applied voltage incorporates said command voltage and a voltage to reduce the electrical dynamics of said electrical DC motor.

2. The method as set forth in claim 1, wherein a positive current feedback voltage determines said voltage to reduce the electrical dynamics of said electrical DC motor.

3. The method as set forth in claim 1, wherein a positive feedback compensator determines said voltage to reduce the electrical dynamics of said electrical DC motor.

4. The method as set forth in claim 1, wherein a negative impedance convertor determines said voltage to reduce the electrical dynamics of said electrical DC motor.

5. The method as set forth in claim 1, wherein the electrical dynamics of said electrical DC motor comprises resistance and inductance.

6. The method as set forth in claim 1, wherein said electrical DC motor is a linear motor or a rotary motor.
